(19) United States
(12) Patent Application Publication
(10) Pub. No.: US 2026/0365045 A1
(43) Pub. Date: Nov. 19, 2026

(54) FUEL CELL AIR MACHINE MOUNTING ASSEMBLY

(71) Applicant: GM Global Technology Operations LLC, Detroit, MI (US)

(72) Inventors: Karthick P. Ghawalkar, Bangalore (IN); Rajeev Reddy Kalakota, Andhra Pradesh (IN); Venkata Subba Rao Mattupalli, Bengaluru (IN)

(73) Assignee: GM Global Technology Operations LLC, Detroit, MI (US)

(21) Appl. No.: 19/206,177

(22) Filed: May 13, 2025

(51) Int. Cl. B60L 50/71; F16B 19/02; F16M 13/02; H01M 8/04111

(52) U.S. Cl. CPC B60L 50/71; F16B 19/02; F16M 13/02; H01M 8/04111; H01M 2250/20

(57) ABSTRACT

A bracket includes a body defining a first aperture and a second aperture spaced apart from the first aperture along a longitudinal axis of the body. A first pin extends into the first aperture in a first direction substantially parallel to the longitudinal axis of the body. A first hollow pin extends into the second aperture in the first direction substantially parallel to the longitudinal axis of the body. The first hollow pin is configured to receive a first fastener to secure the body to the machine in a secured state.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a mounting bracket assembly for mounting a suspended assembly, in particular for mounting an air compressor assembly to a frame and supporting the air compressor assembly once mounted.

Fuel cell systems in vehicles are becoming increasingly popular due to their efficiency and environmentally friendly nature. A critical component of these systems is the air compressor, which supplies the necessary air to the fuel cell to facilitate the electrochemical reaction that generates electricity.

During manufacturing of the vehicle, air compressors must be securely mounted to vehicle structure using one or more brackets. These brackets are designed to withstand the vibrations and stresses encountered during vehicle operation while maintaining the air compressor in a desired position relative to the vehicle structure.

While conventional brackets adequately mount an air compressor to a vehicle structure, it would be beneficial to provide access to the air compressor for servicing and maintenance while installed in the vehicle. Additionally, during installation using a conventional bracket, an installer would need to support the weight of the air compressor while simultaneously mounting the air compressor to the bracket and vehicle structure. The brackets must be precisely aligned and securely fastened to both the compressor and the vehicle structure. This often requires specialized tools and expertise Given these challenges, there is a need for improved mounting solutions for air compressors in vehicle fuel cell systems.

### SUMMARY

In one configuration, a bracket is provided and includes a body defining a first aperture and a second aperture spaced apart from the first aperture along a longitudinal axis of the body. A first pin extends into the first aperture in a first direction substantially parallel to the longitudinal axis of the body. Additionally, a first hollow pin extends into the second aperture in the first direction substantially parallel to the longitudinal axis of the body. The first hollow pin is configured to receive a first fastener to secure the body to the machine in a secured state.

The bracket may include one or more of the following optional features. For example, the bracket may include a first bore that slidably receives the first pin. In one configuration, the first bore may extend from the first aperture to an outer, perimeter surface of the body. The body may include a second bore that receives the first fastener in the secured state. The second bore may be a blind bore having threads that matingly receive threads of the first fastener in the secured state.

The first hollow pin may include a substantially constant inner diameter from a first end of the first hollow pin to a second end of the first hollow pin. The first pin may be aligned with the first hollow pin along an axis that is substantially parallel to the longitudinal axis of the body. The body may include a third aperture disposed adjacent to the first aperture and spaced apart from both the first aperture and the second aperture. The bracket may further comprise a second pin extending into the third aperture in the first direction substantially parallel to the longitudinal axis of the body and a second hollow pin extending into the second aperture in the first direction substantially parallel to the longitudinal axis of the body. The second hollow pin may be configured to receive a second fastener to secure the body to the machine in the secured state. The second pin may be aligned with the second hollow pin along an axis that is substantially parallel to the longitudinal axis of the body.

In another configuration, a bracket is provided and includes a body defining a first aperture and a second aperture spaced apart from the first aperture along a longitudinal axis of the body. A pin extends into the first aperture in a first direction substantially parallel to the longitudinal axis of the body. A blind bore is spaced apart from the pin by the first aperture and extends into the body in a second direction opposite the first direction. The blind bore is configured to receive a fastener to secure the body to the machine in a secured state.

The bracket may include one or more of the following optional features. For example, the bracket may further comprise a hollow pin extending into the blind bore. The hollow pin may be configured to receive the fastener in the secured state. The body may include a bore that slidably receives the pin. The bore may extend from the first aperture to an outer, perimeter surface of the body. The blind bore may include threads that matingly receive threads of the fastener in the secured state. A fuel cell system may incorporate the bracket and machine. A vehicle may incorporate the fuel cell system.

In yet another configuration, a bracket is provided and includes a body defining a first aperture and a second aperture spaced apart from the first aperture along a longitudinal axis of the body. A first pin extends into the first aperture in a first direction substantially parallel to the longitudinal axis of the body. A second pin extends into the second aperture in the first direction substantially parallel to the longitudinal axis of the body. The bracket also includes a blind bore spaced apart from the first pin by the first aperture, spaced apart from the second pin by the second aperture, and extending into the body in a second direction opposite the first direction. The bracket includes a fastener threadably received by the blind bore and configured to move the first pin and the second pin in the first direction and further into the first aperture and the second aperture, respectively, as the fastener is moved in the second direction within the blind bore.

The bracket may include one or more of the following optional features. For example, the bracket may further comprise a hollow pin extending into the blind bore. The hollow pin may be configured to receive the fastener. The hollow pin may include a substantially constant inner diameter from a first end of the hollow pin to a second end of the hollow pin.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle incorporating a fuel cell system having an air compressor and mounting bracket in accordance with the principles of the present disclosure;

FIG. 2 is a top view of a mounting bracket according to the principles of the present disclosure;

FIG. 3 is a perspective view of the mounting backet of FIG. 2;

FIG. 4 is a top view of the air compressor and mounting bracket of FIG. 1 in a disengaged state showing the mounting bracket disengaged from the air compressor;

FIG. 5 is a cross-sectional side view of the air compressor and mounting bracket of FIG. 1 in a disengaged state showing the mounting bracket engaged from the vehicle and disengaged from the air compressor;

FIG. 6 is a top view of the air compressor and mounting bracket of FIG. 1 in an engaged state showing the mounting bracket engaged with the vehicle and engaged with the air compressor;

FIG. 7 is a cross-sectional side view of the air compressor and mounting bracket of FIG. 1 in an engaged state showing the mounting bracket attached to the vehicle and to the air compressor;

FIG. 8 is a cross-sectional view of the mounting bracket of FIG. 1.

FIG. 9 is a top view of the mounting bracket of FIG. 1 in an engaged state showing the mounting bracket engaged with the vehicle, and in a disengaged state with respect to the air compressor.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The present disclosure aims to provide an improved mounting solution for an air compressor in a vehicle fuel cell system. Specifically, the present disclosure relates to a mounting bracket assembly that is simple to attach, allows for access to the air compressor assembly while mounted, and allows the air compressor assembly to be dismounted without removing the mounting bracket from the frame.

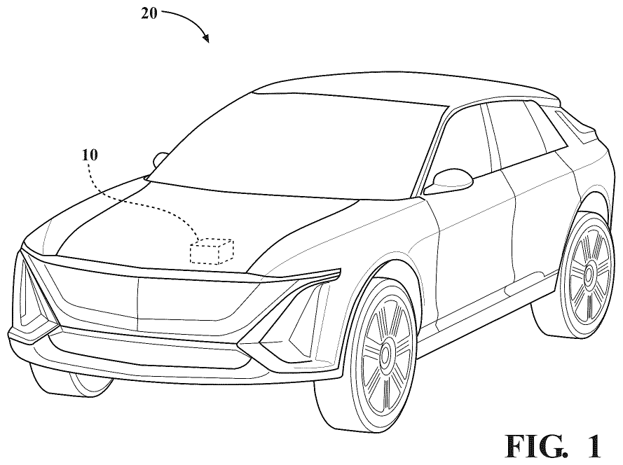

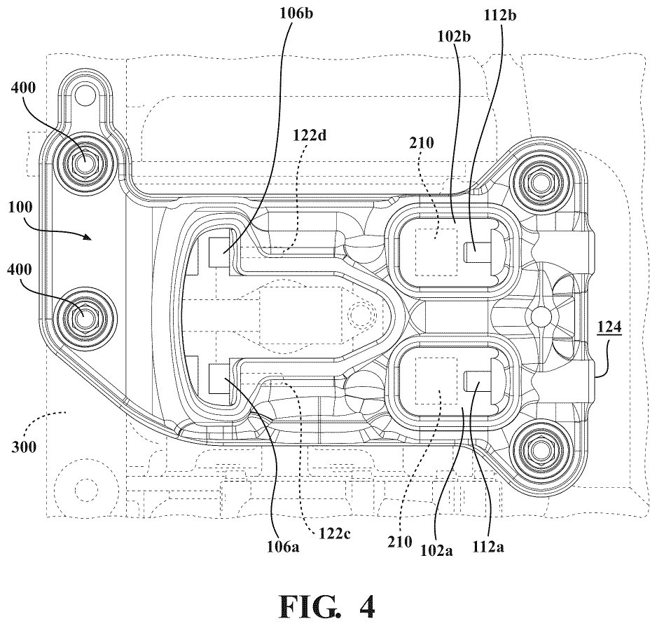

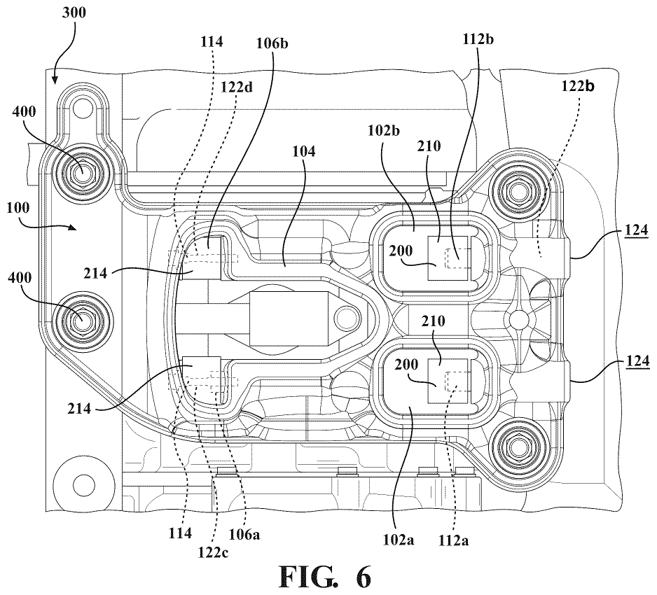

Referring to FIG. 1, a fuel cell system 10 is generally shown. The fuel cell system may be installed in a vehicle 20, or other suitable mounting environment. The fuel cell system 10 generally includes a mounting bracket 100 and a machine 200 (e.g., FIGS. 4-6).

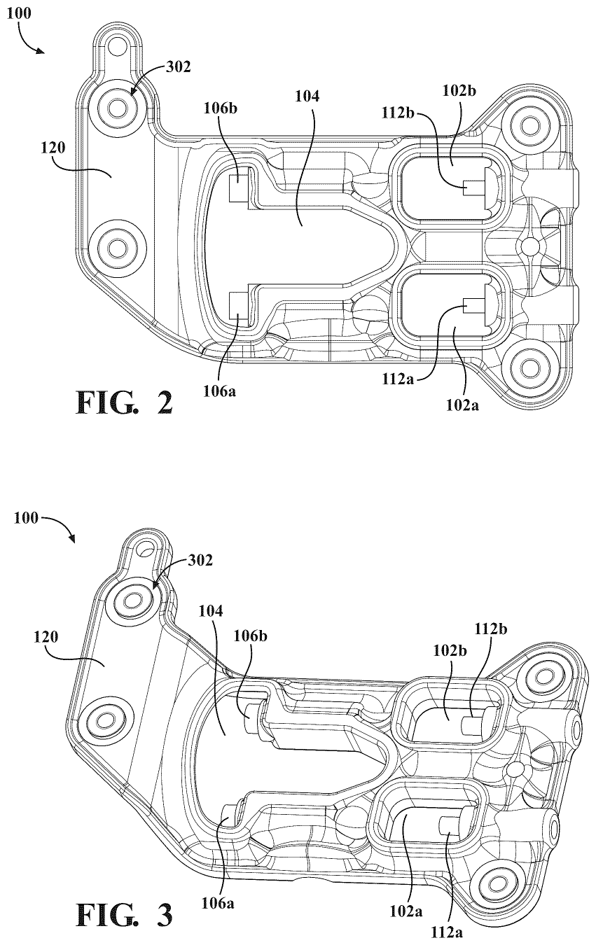

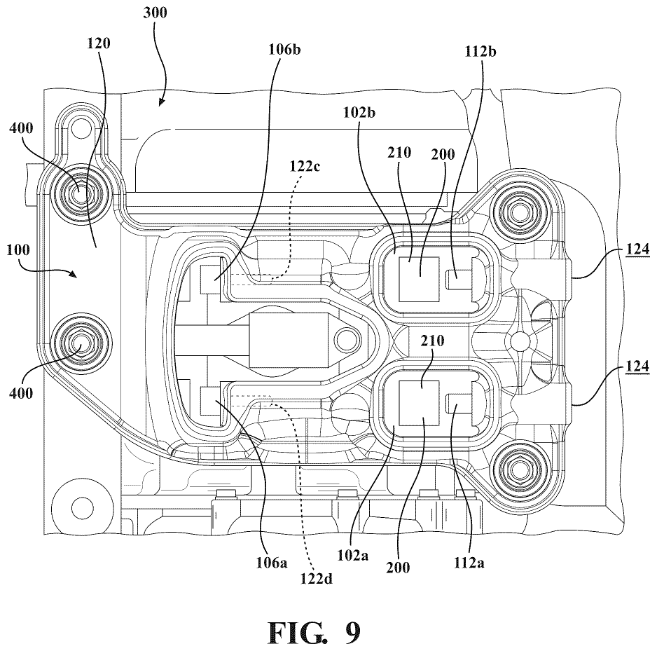

Referring to FIGS. 2 and 3, a mounting bracket 100 is shown. The mounting backet 100 may be coupled with a machine 200 (e.g., an air compressor) and installed in a vehicle or other suitable mounting environment. An exemplary aspect of the bracket 100 coupled with the machine 200 and installed in a vehicle 20 is best shown in FIG. 9. As shown, the mounting bracket 100 includes a main body 120, and the main body 120 generally includes a first aperture 102a, a second aperture 102b, and a third aperture 104. A first pin 112a extends into the first aperture 102a in a first direction substantially parallel to the longitudinal axis of the body 120. Additionally, a first hollow pin 106a extends into the third aperture 104 in a first direction substantially parallel to the longitudinal axis of the body 120. A second pin 112b extends into the second aperture 102b in the first direction substantially parallel to the longitudinal axis of the body 120. Additionally, a second hollow pin 106b extends into the third aperture 104 in the first direction substantially parallel to the longitudinal axis of the body 120. Additionally, the body 120 may be configured to receive an isolation system 302, the isolation system 302 configured to reduce vibration effects on the bracket 100 and the bolts fastening the bracket 100, as set forth below.

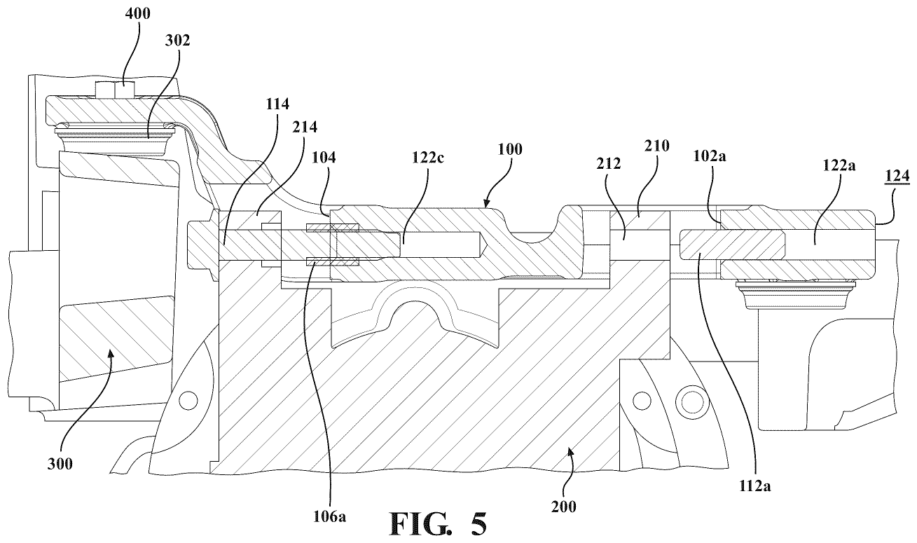

Referring to FIGS. 4 and 5, the bracket 100 may be coupled to an aspect 300 (e.g., a fuel cell) of the vehicle 10. Namely, the bracket 100 may be coupled to the fuel cell 300. In some examples, the bracket 100 may be coupled to the fuel cell 300 by at least one threaded fastener 400. The threaded fastener(s) 400 may include a bolt and an isolator 302 or dampener.

The bracket 100 may be configured to slidably receive the machine 200. The body 120 further may include a first bore 122a and a second bore 122b. The first bore 122a may extend from the first aperture 102a to an outer, perimeter surface 124 of the body 120. The second bore 122b may extend from the second aperture 102b to the outer, perimeter surface 124 of the body 120. Each of the first bore 122a and the second bore 122b receives a respective portion of the first and second pins 112a, 112b. In so doing, a portion of the first pin 112a is received by the first bore 122a and another portion of the pin 112a extends into the first aperture 102a. Similarly, a portion of the second pin 112b is received by the second bore 122b and another portion of the pin 112b extends into the second aperture 102b. These pins 112a, 112b are therefore cantilevered from the body 120 and extend into the respective apertures 102a, 102b.

The main body 120 may also include a first blind bore 122c and a second blind bore 122d. The blind bores 122c, 122d are respectively aligned with and receive a portion of the first hollow pin 106a and the second hollow pin 106b. As shown in FIG. 5, the hollow pins 106a, 106b extend from openings of the respective blind bores 122c, 122d and into the third aperture 104. As will be described, the pins 106a, 106b each receive a first fastener 114 in a secured state where the machine 200 is secured to the bracket 100. The blind bores 122c, 122d may each include threads that matingly receive threads of the fasteners 114 in the secured state to fixedly attach the machine 200 to the bracket 100 and, thus, to the fuel cell 300.

As shown in FIGS. 2 and 3, the first pin 112a is aligned with the first hollow pin 106a along an axis that is substantially parallel to the longitudinal axis of the body 120 and the first pin 112b is aligned with the second hollow pin 106b along the axis that is substantially parallel to the longitudinal axis of the body 120.

In operation, the machine 200 may receive the fastener 114 before or after the machine 200 is slidably received by the bracket 100. In an unsecured state, the machine 200 is not engaged with the first pin 112a, the second pin 112b, or any fasteners 114. It should be understood that in some exemplary aspects, the bracket 100 may slidably receive the machine 200 without being coupled to the fuel cell 300. It should also be understood that in some exemplary aspects, the bracket 100 may be coupled to the fuel cell 300 and the bracket 100 may then slidably receive the machine 200. It should also be understood that in some exemplary aspects, the bracket 100 may be slidably coupled with the machine 200 and coupled to a device in a testing environment, such as a fuel cell on a test bench

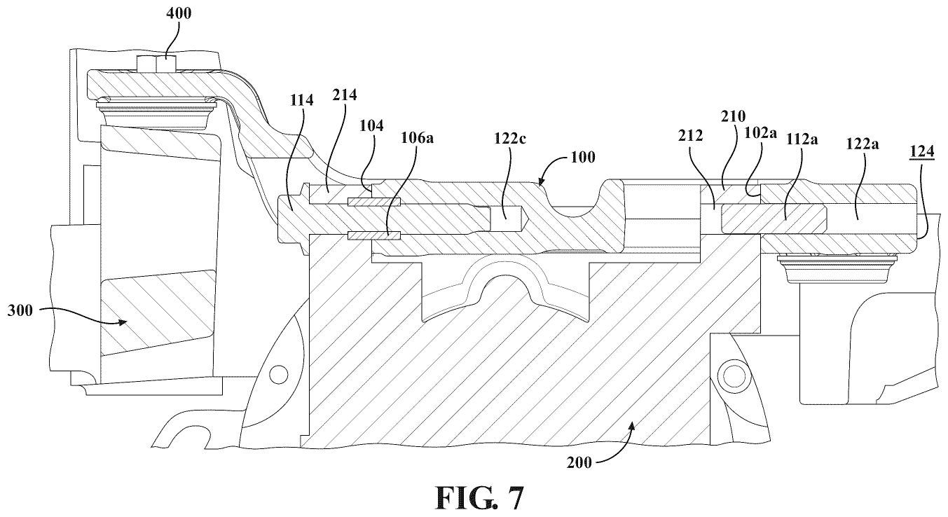

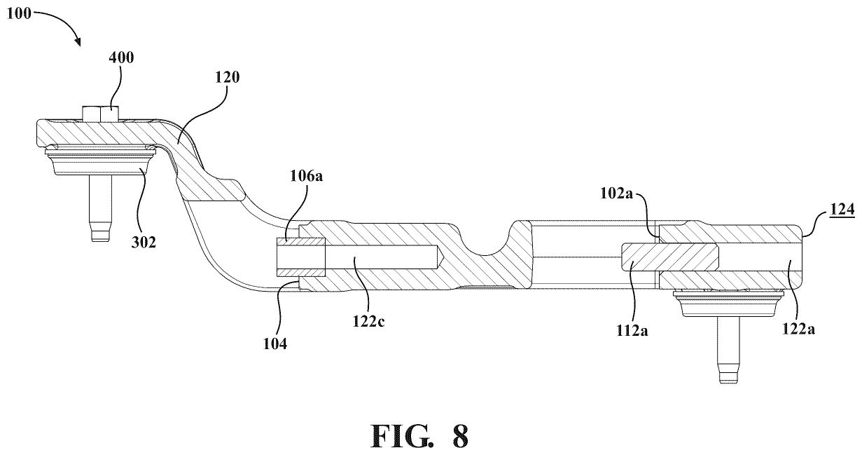

The bracket 100 may slidably receive the machine 200 to fix a position of the machine 200 relative to the bracket 100. If the bracket 100 is attached to the fuel cell 300, fixing a position of the machine 200 relative to the bracket 100 likewise fixes a position of the machine 200 relative to the fuel cell 300. Initially, the machine 200 may be positioned relative to the bracket 100 such that flanges 210 of the machine 200 engage and receive the respective pins 112a, 112b. Specifically, apertures 212 of the flanges 210 receive the respective pins 112a, 112b when the machine 200 is sufficiently translated (i.e., moved) relative to the bracket 100. In so doing, the machine 200 is suspended from the pins 112a, 112b and held in place due to engagement between the flanges 210 and the pins 112a, 112b. In this position, the flanges 210 of the machine 200 extend into and are received by the respective apertures 102a, 102b. In addition, the flanges 214 receive the respective pins 106a, 106b such that the machine 200 is suspended by and attached to the bracket 100 by the pins 106a, 106b. As shown in FIG. 7, the flanges 214 extend into the third aperture 104 to allow the flanges 214 to be aligned with and engage the pins 106a, 106b.

At this point, the fasteners 114 may be inserted through separate flanges 214 of the machine 200 (FIGS. 5 and 7) and into the respective pins 106a, 106b. As shown in FIGS. 5 and 7, in this position, the flanges 214 of the machine 200 extend up and into the third aperture 104 and are separately aligned with the pins 106a, 106b and bores 122c, 122d. In this position, the fasteners 114 may be inserted through the flanges 214 and into the pins 106a, 106b. Once the fasteners 114 are sufficiently received by and extend through the pins 106a, 106b, the fasteners 114 threadably engage the threaded, blind bores 122c, 122d to fixedly attach the machine 200 to the bracket 100 and, thus, to the fuel cell 300.

The machine 200 may be removed from the bracket 100 by first removing the fasteners 114 from the bores 122c, 122d and from the pins 106a, 106b. At this point, the machine 200 is still held in position relative to the bracket 100 due to engagement between the pins 112a, 112b and the flanges 210 of the machine 200 and between the pins 106a, 106b and the flanges 214 of the machine 200. A force may be applied to the machine 200 to slide or translate the machine 200 relative to the bracket 100, thereby causing the flanges 210, 214 to slide along the respective pins 112a, 112b, 106a, 106b until the flanges 210, 214 disengage the pins 112a, 112b, 106a, 106b. At this point, the flanges 210, 214 may be removed from the respective apertures 102a, 102b, 104 and the machine 200 may be removed from the bracket 100. If the bracket 100 is attached to the fuel cell 300, the machine 200 is likewise removed from the fuel cell 300 while the bracket 100 remains attached to the fuel cell 300.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A bracket for mounting a machine relative to an external structure, the bracket comprising:
a body defining a first aperture and a second aperture spaced apart from the first aperture along a longitudinal axis of the body;
a first pin extending into the first aperture in a first direction substantially parallel to the longitudinal axis of the body; and
a first hollow pin extending into the second aperture in the first direction substantially parallel to the longitudinal axis of the body, the first hollow pin configured to receive a first fastener to secure the body to the machine in a secured state.

2. The bracket of claim 1, wherein the body includes a first bore that slidably receives the first pin.

3. The bracket of claim 2, wherein the first bore extends from the first aperture to an outer, perimeter surface of the body.

4. The bracket of claim 2, wherein the body includes a second bore that receives the first fastener in the secured state.

5. The bracket of claim 4, wherein the second bore is a blind bore having threads that matingly receive threads of the first fastener in the secured state.

6. The bracket of claim 5, wherein the first hollow pin includes a substantially constant inner diameter from a first end of the first hollow pin to a second end of the first hollow pin.

7. The bracket of claim 1, wherein the first pin is aligned with the first hollow pin along an axis that is substantially parallel to the longitudinal axis of the body.

8. The bracket of claim 1, wherein the body includes a third aperture disposed adjacent to the first aperture and spaced apart from both the first aperture and the second aperture.

9. The bracket of claim 8, further comprising a second pin extending into the third aperture in the first direction substantially parallel to the longitudinal axis of the body and a second hollow pin extending into the second aperture in the first direction substantially parallel to the longitudinal axis of the body, the second hollow pin configurated to receive a second fastener to secure the body to the machine in the secured state.

10. The bracket of claim 9, wherein the second pin is aligned with the second hollow pin along an axis that is substantially parallel to the longitudinal axis of the body.

11. A bracket for mounting a machine relative to an external structure, the bracket comprising:
a body defining a first aperture and a second aperture spaced apart from the first aperture along a longitudinal axis of the body;
a pin extending into the first aperture in a first direction substantially parallel to the longitudinal axis of the body; and
a blind bore spaced apart from the pin by the first aperture and extending into the body in a second direction opposite the first direction, the blind bore configured to receive a fastener to secure the body to the machine in a secured state.

12. The bracket of claim 11, further comprising a hollow pin extending into the blind bore, the hollow pin configured to receive the fastener in the secured state.

13. The bracket of claim 11, wherein the body includes a bore that slidably receives the pin.

14. The bracket of claim 13, wherein the bore extends from the first aperture to an outer, perimeter surface of the body.

15. The bracket of claim 14, wherein the blind bore includes threads that matingly receive threads of the fastener in the secured state.

16. A fuel cell system incorporating the bracket and machine of claim 11.

17. A vehicle incorporating the fuel cell system of claim 16.

18. A bracket for mounting a machine relative to an external structure, the bracket comprising:
a body defining a first aperture and a second aperture spaced apart from the first aperture along a longitudinal axis of the body;
a first pin extending into the first aperture in a first direction substantially parallel to the longitudinal axis of the body;
a second pin extending into the second aperture in the first direction substantially parallel to the longitudinal axis of the body;
a blind bore spaced apart from the first pin by the first aperture, spaced apart from the second pin by the second aperture, and extending into the body in a second direction opposite the first direction; and
a fastener threadably received by the blind bore and configured to move the first pin and the second pin in the first direction and further into the first aperture and the second aperture, respectively, as the fastener is moved in the second direction within the blind bore.

19. The bracket of claim 18, further comprising a hollow pin extending into the blind bore, the hollow pin configured to receive the fastener.

20. The bracket of claim 19, wherein the hollow pin includes a substantially constant inner diameter from a first end of the hollow pin to a second end of the hollow pin.
